(19) United States
(12) Patent Application Publication
(10) Pub. No.: US 2023/0296046 A1
(43) Pub. Date: Sep. 21, 2023

(54) Generator Unit Comprising Vehicle Engine and Dry Cooler Heat Exchanger

(71) Applicant: ARUANÃ ENERGIA S/A, Goiânia (BR)

(72) Inventors: Sandro Marchini, São Paulo (BR); Brian Ray Brewer, São Paulo (BR); Robert James McKinnon, São Paulo (BR)

(21) Appl. No.: 18/185,907

(22) Filed: Mar. 17, 2023

(30) Foreign Application Priority Data
Mar. 18, 2022 (BR) 102022005074-0
Apr. 13, 2022 (BR) 132022007149-6

(51) Int. Cl. F02B 63/04

(52) U.S. Cl. CPC F02B 63/044

(57) ABSTRACT

An autonomous modular device for an electric generating plant is described which may be in the form of a container that makes use of a vehicular engine adjacent to the canopy of a modular structure. A drycooler heat exchanger, with a layout different from the other existing layouts, implying improvements in the use of this type of autonomous generator system, is provided insofar as it provides easy transport, adequate consumption without mechanical loss and high energy efficiency. In one embodiment the vehicular engine is placed under the canopy of the modular structure, wherein a drycooler heat exchanger is accommodated, and not an engine radiator, with a different arrangement from the other existing units. A second embodiment is adapted to places where there is no physical space for the model including the heat exchanger under the canopy, forcing the installation on the ceiling of the installation, or for other installations.

### CROSS-REFERENCE TO RELATED APPLICATIONS

This application claims the benefit of and priority to Brazil Patent Application No. 102022005074-0, filed Mar. 18, 2022, and Brazil Patent Application No. 132022007149-6, filed Apr. 13, 2022, the contents of both of which being incorporated by reference in their entireties herein.

### TECHNICAL FIELD

The present application refers to a device for electric generator units, in which, in particular, such device is supplied in the form of a container or canopy. The device makes use of a vehicular engine in which, under the canopy of a modular structure, a dry cooler heat exchanger is accommodated, and not an engine radiator, with a different arrangement from the other existing units. In a possible embodiment, the dry cooler heat exchanger is not accommodated under the canopy, but is detached from the modular structure.

### BACKGROUND

Modular generator units allow the supply of electricity in standby mode, prime power, or continuous use, mainly in industrial, commercial buildings, remote areas, such as isolated rural communities, mining fields, oil platforms, areas recently affected by storms, areas affected by earthquakes, offshore platforms, etc., or areas in conflict or where other demanding circumstances are present.

In general, generator units are made up of containers, canopies, or similar structures in which generator units are installed with cooling provided by propellers coupled directly to the engine. However, although conventional generator units provide electrical energy, they can be designed more efficiently in such a way they consume less fuel in the generation of each kilowatt-hour.

### BRIEF SUMMARY

Thus, with the aim of providing improvements to the consumer market, an autonomous system is described, supplied in the form of a container, that makes use of a vehicle engine, powered by natural gas, biogas, diesel oil, biodiesel, or hydrogen. A canopy or container of the modular structure supports a heat exchanger as a drycooler not mechanically coupled to the engine, in which the autonomous generator unit, with the use of a vehicular engine, allows a compact unit, easy to transport, and which allows gain in efficiency and mitigated mechanical loss through the use of small high-efficiency electric fans that blow the drycooler, effecting the heat exchange between the circulating water in the drycooler and the air that is forced through its coils.

In some aspects, the drycooler heat exchanger is not accommodated under the canopy, but is detached from the modular structure. This solution is especially adapted to places where there is no physical space for the model including the heat exchanger under the canopy, forcing the installation on the ceiling of the generator unit, or for installations in buildings wherein the drycooler needs to be installed outside the building, or installation in powerhouses with multiple open generator units installed. In one embodiment, the drycooler heat exchanger is positioned next to said modular structure. In another embodiment, the drycooler heat exchanger is positioned above said modular structure.

### BRIEF DESCRIPTION OF THE DRAWINGS

As a complement to the present description, and in order to allow a better understanding of the characteristics of the generator unit according to a preferred embodiment thereof, the present description is accompanied by a set of drawings that include, for illustrative purposes and non-limiting, the following:

FIG. 1 illustrates a perspective view of the generator unit, highlighting a cold air inlet face, where fans, containment drain, tank drain, and emergency button are located;

FIG. 2 illustrates another perspective view of the generator unit, highlighting the opposite face of the cold air inlet, which is the access face to the silencer, also emphasizing the combustion gas outlet (exhaust), hot air outlet drycooler, fairing lifting points and assembly lifting points;

FIG. 3 is an exploded view of the generator unit;

FIG. 4 is an isometric view of the assembled base and fairing of the generator unit of the present application;

FIG. 5 illustrates a perspective view of the generator unit, in an embodiment in which the heat exchanger is positioned in a neighboring building, away from the modular structure;

FIG. 6 illustrates a perspective view of the generator unit, in a mode in which the heat exchanger is removed from the modular structure;

FIG. 7 illustrates a perspective view of the generator unit, in a mode in which the heat exchanger is moved away from the modular structure, in yet another position with respect to the modular structure;

FIG. 8 illustrates a perspective view of the generator unit, in a mode in which the heat exchanger is moved away from the modular structure, in yet another position with respect to the modular structure;

FIG. 9 illustrates a perspective view of the generator unit, in a mode in which the heat exchanger is moved away from the modular structure, in yet another position with respect to the modular structure;

FIG. 10 illustrates a perspective view of the generator unit, in an embodiment in which the heat exchanger is removed from the modular structure, but is located immediately above the modular structure;

FIG. 11 illustrates a perspective view of the generator unit, in an embodiment in which the modular structure is positioned inside a construction (or shelter) and the heat exchanger, away from the modular structure, is positioned on the external side of this same construction; and

FIG. 12 illustrates a perspective view of the generator unit, in an embodiment in which the modular structure is positioned inside a construction (or shelter) and the heat exchanger, away from the modular structure, is positioned outside this same construction.

### DETAILED DESCRIPTION

With reference to the aforementioned drawings, this application refers to a generator unit comprising a vehicle engine, powered by natural gas, biogas, diesel oil, or biodiesel, and a drycooler heat exchanger. More specifically, an autonomous system is described, of the type supplied in the form of a container, that makes use of a vehicular engine in which a canopy or container, of the modular structure supports a drycooler heat exchanger not mechanically coupled to the engine unit, in which the autonomous generator unit with the use of an engine vehicular provides a compact unit that is easy to transport, and that allows gain in efficiency and mitigated mechanical loss.

Generally, the use of a propeller coupled to the engine causes efficiency losses that can be improved with the use of air/water heat exchangers called industrial drycoolers, typically used in large-scale air conditioning systems and industrial heat removal processes, among others. Alternative includes systems that use the propeller and the radiator of a vehicle engine, mechanically decoupled from the engine, with the propeller driven by a common electric motor. However, this alternative was not efficient in terms of use. Therefore, a solution involving a vehicle engine in this type of modular configuration of generator units remains in the state of the art.

Thus, it is desirable to continue to maintain an optimal temperature exchange of the generator unit powered by the vehicular combustion engine in the inside the container or canopy by means of a drycooler heat exchanger, thus solving some of the current problems. The present disclosure stands out for the fact that are used herein drycoolers which are specifically developed for vehicular engines that have been readjusted.

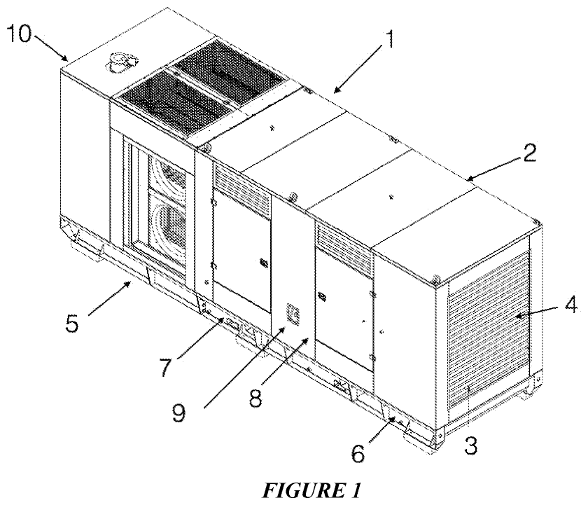

As illustrated in FIG. 1, a generator unit in modular form (1) is shown that is supplied in the form of a container, canopy, or fairing (2) wherein, at one end, cold air (3) enters, which gives access to the electric fans of the drycooler (4) and at the opposite end there is access to the silencer (10). At the base (5) are arranged a containment drain (6) and a tank drain (7), and on its side (8), an emergency button (9), in addition to provisions for manual filling, cable exit, access to the controller and entrance to the drycooler heat exchanger.

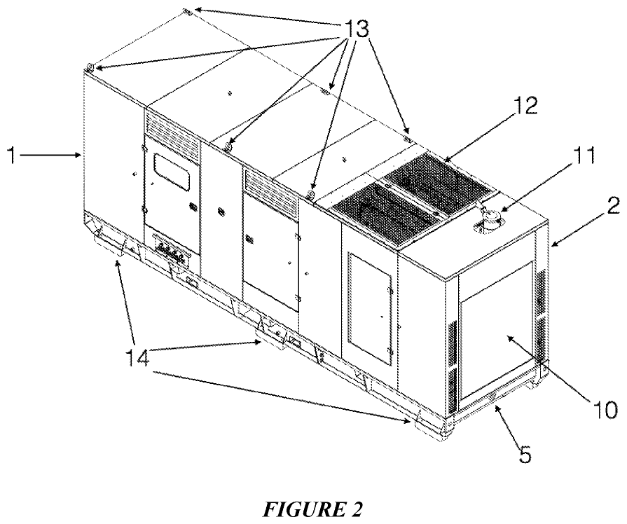

As shown in FIG. 2, an exhaust/flue gas outlet (11) is located near the access to the silencer (10) and also the hot air outlet of the drycooler (12). It is worth noting that the lifting points arranged on the canopy (13) are intended to remove the fairing (2) from above the base (5), while said base (5) comprises lifting points of the unit (14).

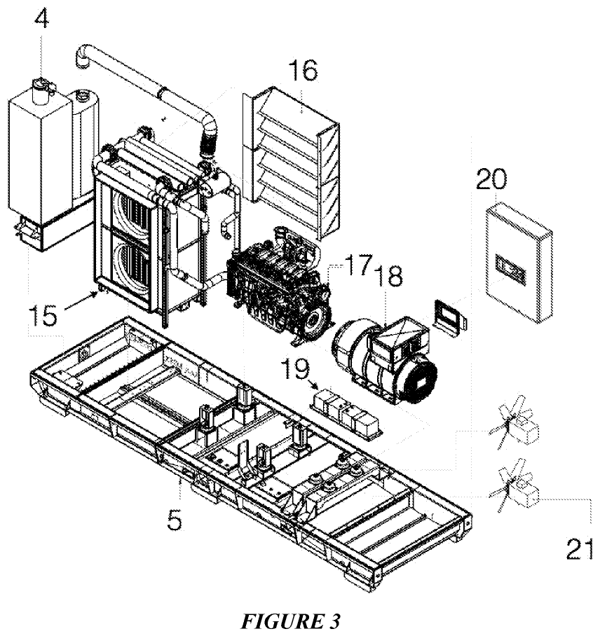

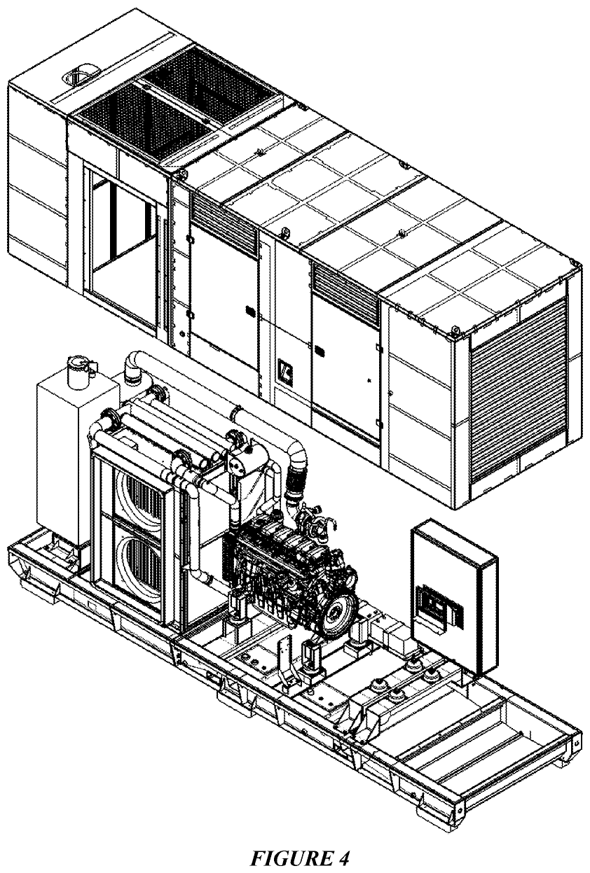

FIGS. 3 and 4, showing an exploded view, illustrate the arrangement according to the present application, custom-developed for the vehicle engine configuration according to the present disclosure.

A drycooler-type heat exchanger (15), with drycooler output baffles (16), in which the drycooler heat exchanger is used, adapted, or configured to cool the vehicle engine (17), coupled to a main alternator (18), starter batteries (19), and a control panel (20). The assembly supported by the base further comprises fans for air intake in the engine compartment (21).

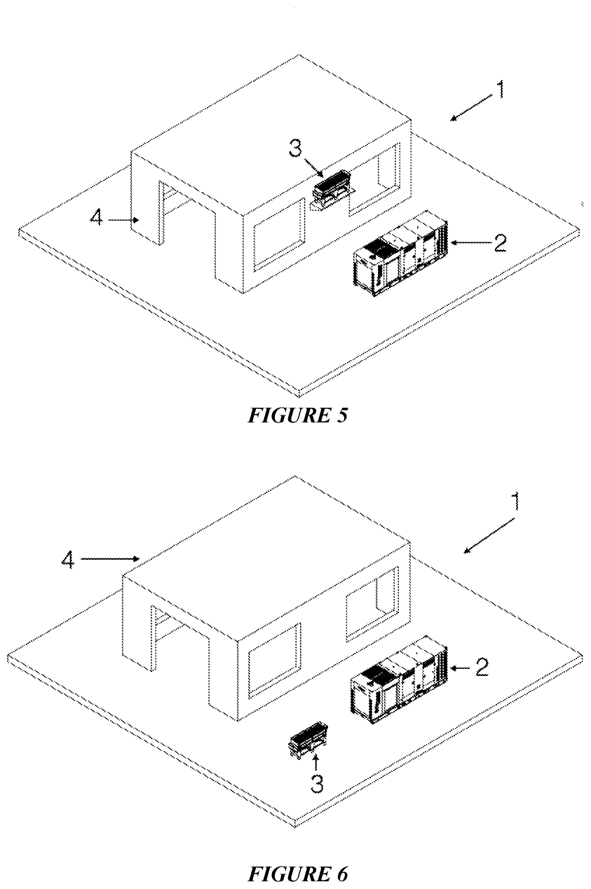

As illustrated in FIG. 5, said generator set in modular form (1) is supplied in the form of a container, canopy, or fairing (2), where there is no direct contact with the drycooler heat exchanger (3). In this embodiment, the drycooler heat exchanger (3) rests on a construction (4) close to the canopy structure (2).

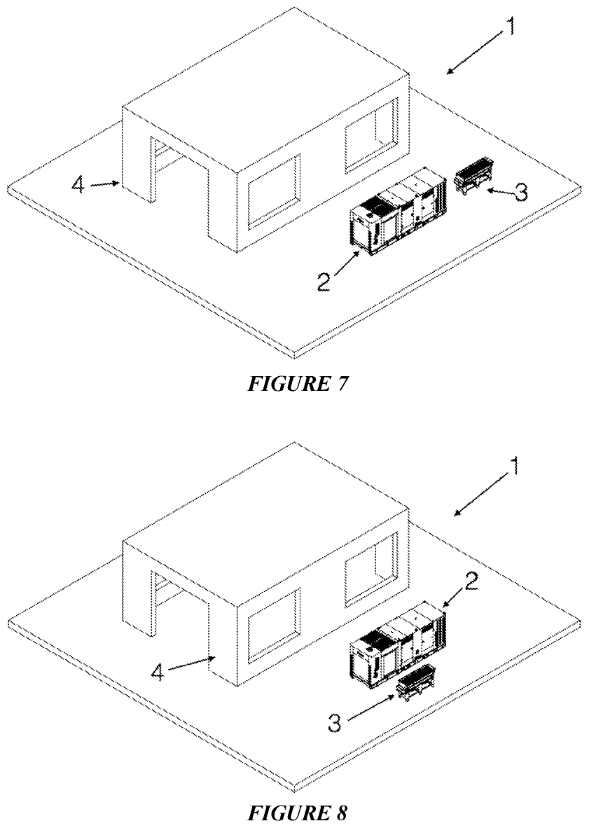

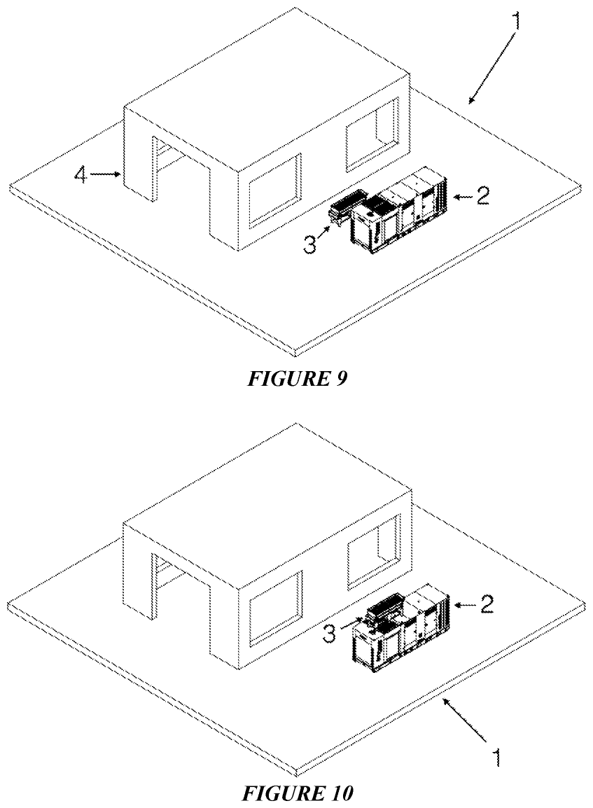

As shown in FIGS. 6 to 9, said generator set in modular form (1) is supplied in the form of a container, canopy or fairing (2) wherein there is no direct contact with the drycooler heat exchanger (3). In this conformation, the drycooler heat exchanger (3) is located close to the sides, front or rear of the canopy structure (2).

As illustrated in FIG. 10, said generator set in modular form (1) is supplied in the form of a container, canopy or fairing (2) that supports the drycooler heat exchanger (3). In this embodiment, the drycooler heat exchanger (3) rests on top of the canopy structure (2).

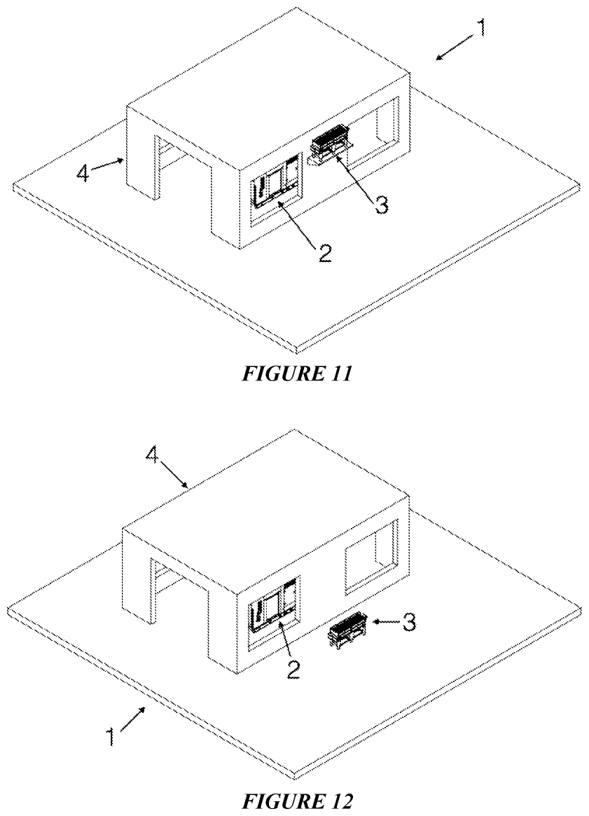

As illustrated in FIG. 11, said generator set in modular form (1) is provided in the form of a container, canopy or fairing (2) that is located within a support building or shelter (4). In this embodiment, the drycooler heat exchanger (3) rests on the side of the support or shelter construction (4). In FIG. 8, said generator set in modular form (1) is provided in the form of a container, canopy or fairing (2) which is located inside a support construction or shelter (4) and wherein the drycooler heat exchanger (3) is spaced from, but close to, the support or shelter construction (4).

In summary, this application discloses a generator unit configuration and an autonomous system, in which a vehicle engine is cooled through a drycooler heat exchanger not coupled to the engine, aiming at an alternative to the common way, which consists of a propeller coupled to and moved by an engine or engine itself and a common radiator used in vehicles, which is normally supplied by the engine manufacturer as an integral part of the assembly, and which consumes much more fuel in terms of kilowatt hours of consumption of fuel. This set, developed for this specific engine configuration, provides maximum mechanical power with lower engine consumption, operating in the absence of propellers, alternator, and battery alternator.

The compact configuration allows easy unit transport, with the generator unit and drycooler comprised in a single module, under the same canopy, fairing or container.

Other embodiments of this compact configuration also allow easy transport, with the generator unit and drycooler are provided in a detached/separate way, and not under the same canopy, fairing or container. This solution is especially adapted to places where there is no physical space for the model including the heat exchanger under the canopy, forcing the installation on the ceiling of the installation, or for installations in buildings wherein the drycooler needs to be installed outside the building, or installation in powerhouses with multiple open generator sets installed. The module offers significant advantages compared to the documents of the state of the art, perfectly fitting the patentability criteria insofar as it implements a tailor-made combination and development for the use of vehicular engines in generator sets, resulting in an improvement with new use of this type of engine, by means of a drycooler heat exchanger not mechanically coupled to the engine.

Preferred embodiments of this application have been described, with the proviso that any changes and/or alterations are to be understood as being within the scope of this application as presented.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A generator system module, comprising:
a container, canopy, or fairing and a base on which cold air intakes are installed providing access to fans and, at the opposite end, access to a muffler;
a containment drain and a tank drain arranged at the base, and on its side, an emergency button, in addition to provisions for manual supply, output of cables, controller access, and a drycooler heat exchanger inlet;
an exhaust/flue gas outlet located close to an access to the muffler and to a hot air outlet of the drycooler; and
a drycooler heat exchanger with drycooler output deflectors, wherein the drycooler heat exchanger is configured to cool a vehicle engine, coupled to a main alternator, starter batteries, and a control panel, the set supported by the base and fans for engine intake.

2. The generator system module according to claim 1, wherein there is no direct contact with the drycooler heat exchanger and the container, canopy, or fairing.

3. The generator system module according to claim 2, wherein the drycooler heat exchanger rests on a support construction close to a canopy structure.

4. The generator system module according to claim 2, wherein the drycooler heat exchanger is located close to sides, front, or rear of a canopy structure.

5. The generator system module according to claim 2, wherein the drycooler heat exchanger rests on top of the canopy structure.

6. The generator system module according to claim 2, wherein the drycooler heat exchanger rests on the side of a support construction or a shelter construction, which houses the one container, canopy, or fairing.

7. The generator system module according to claim 2, wherein the container, canopy, or fairing is located within a support construction or a shelter construction and wherein the drycooler heat exchanger is spaced from, but close to, the support or shelter construction.

8. A method, comprising:
providing the generator system module according to claim 1; and
using a vehicle engine in conjunction with the drycooler heat exchanger of the generator system module.
